(19) United States
(12) Patent Application Publication
(10) Pub. No.: US 2025/0096564 A1
(43) Pub. Date: Mar. 20, 2025

(54) A METHOD FOR PROVIDING USAGE INFORMATION OF AN ELECTRICAL GRID TO A PROVIDER AS WELL AS AN ELECTRONIC COMPUTING DEVICE

(71) Applicant: MERCEDES-BENZ GROUP AG, Stuttgart (DE)

(72) Inventors: Mohammad MIRABIAN, San Jose, CA (US); Rene KRESS, Santa Clara, CA (US); Sinan KAZAN, Los Altos, CA (US)

(21) Appl. No.: 18/580,316

(22) PCT Filed: Jul. 8, 2022
(86) PCT No.: PCT/EP2022/069187

§ 371 Date: Jan. 18, 2024

(30) Foreign Application Priority Data
Jul. 19, 2021 (GB) 2110320.5

(51) Int. Cl. H02J 3/06; G06Q 50/06; H02J 3/00

(52) U.S. Cl. CPC H02J 3/06; G06Q 50/06; H02J 3/003; H02J 2203/10

(57) ABSTRACT

A method for providing usage information of an electrical grid to a provider of the electrical grid involves capturing an input of the provider, the input defines a geometrical map in the electrical grid. At least one power consumption of a plurality of motor vehicles is determined in the geometrical map in a time frame, providing at least one time stamp for the at least one power consumption. The at least one power consumption with the at least one time stamp for the defined geometrical map is transferred as the usage information to the provider.

### FIELD OF THE INVENTION

Exemplary embodiments of the invention relate to the field of automobiles. More specifically, the invention relates to a method for providing usage information of an electrical grid to a provider of the electrical grid by an electronic computing device as well as to a corresponding computer program product and a corresponding electronic computing device.

### BACKGROUND INFORMATION

Utilities and grid providers did not have mobility in mind when they established the grid infrastructure. As a result, difficulties in planning and investing for charging infrastructure developments and upgrades can exist. Furthermore, safety related issues may occur due to a grid infrastructure that does not have the capacity to provide sufficient energy and power for local charging needs. The provider needs to be able to monitor and to predict charging demands of at least partially electric motor vehicles, for example hybrid motor vehicles or fully electric motor vehicles, in order to safeguard provisioning of energy, power and charging.

U.S. Pat. No. 10,714,955 B2 discloses a cloud system configured to execute method operations for communicating with connected vehicles of users having user accounts with the cloud system. One example method includes receiving a signal from an electric vehicle associated with a user account. The signal of the electric vehicle is received in response to the electric vehicle parking over a charging pad of a charging unit, and the charging unit is one of a plurality of charging units located in various geo-locations. The method includes sending instructions to the charging unit to enable initiation of charge transfer to a battery of the electric vehicle upon the cloud system confirming that the user account of the electric vehicle is enabled for automatic charging upon parking over the charging pad of the charging unit. The method includes receiving data from the charging unit indicative of a discontinuing of the charge transfer by the charging pad responsive to detecting that the electric vehicle is no longer parked over said charging pad.

US 2016 0379486 A1 discloses an apparatus and a system to manage monitoring the traffic density in relationship to spatial locational flow rates. The system includes a variety of mobile and/or stationary transmitting and receiving comm-devices utilizing certified comm-devices equipped Avics iChipset arranged in a plurality of vehicles, in communication with stationary and/or mobile hub comm-devices and/or other certified comm-devices, strategically arranged within and/or along one or more roadways and in communication with a server channel networked to a central server.

### SUMMARY OF THE INVENTION

Exemplary embodiments of the invention provide a method, a computer program product as well as an electronic computing device by which a provider of an electrical grid can have further information about planning the electrical grid maps.

One aspect of the invention relates to a method for providing usage information of an electrical grid to a provider of the electrical grid by an electronic computing device. An input of the provider is captured, wherein the input defines a geometrical map in the electrical grid. At least one power consumption of a plurality of motor vehicles is determined in the geometrical map in a time frame. At least one timestamp for the at least one power consumption is provided. The at least one power consumption is transferred with the at least one timestamp for the geometrical map as the usage information to the provider. The usage information can be transferred in a form so that no conclusions can be drawn about the identity or origin of the information. This can be achieved by transferring the usage information from the vehicles anonymously and/or anonymizing it at the provider. Alternatively, or additionally, the usage information can be transferred from the each vehicle without a vehicle identification number or with an anonymized vehicle identification number.

This has the advantage that electrical utilities and grid operators need OEM (Original Equipment Manufacturer) charging pattern data to save costs for an electrical infrastructure upgrade. The provider may only invest at locations where the upgrade is needed in the grid map.

Furthermore, the electric utilities, which may be the provider, grid operators, and charging station makers need OEM data to extend public/commercial charging station infrastructure. For an owner of the motor vehicle the charging service incentives from the utility such as a wall-box and/or low energy tariffs are upgraded because of an improved infrastructure and charging power. Furthermore, the charging service incentives from the utility such as the wall-box and/or low energy tariffs may provide better charging power and better station coverage according to the usage information of the electrical grid. This solves the problem of overly high costs for updating the electrical grid infrastructure and may support the provider in a strategic placement of charging infrastructure stations.

Therefore, the provider is enabled to more efficiently plan and upgrade their infrastructure by offering data, such as (but not limited to) battery state of charge data including time stamp and aggregated vehicle location. Furthermore, the provider may offer new functionalities and services to an owner or user of the motor vehicle, such as charging service incentives and optimizing battery energy usage. By utilizing OEM charging data, utilities, grid operators, and charging infrastructure providers will be able to monitor, track, and predict charging patterns. These organizations need to economically provide infrastructure and to prevent energy shortages or blackouts in the grid. Furthermore, by monitoring the at least partially electrified motor vehicles that are parked and not charged for a certain period, utilities, grid operators and charging station providers will be able to expand charging infrastructure to new locations.

According to an embodiment, the at least one power consumption is aggregated depending on each power consumption of each motor vehicle of the plurality of motor vehicles. In particular, the motor vehicle may be an electrified motor vehicle. The motor vehicle may be at least partially electrified such as a hybrid motor vehicle. The energy consumption is then aggregated by adding the power consumption of each motor vehicle in the geometrical map.

In another embodiment each motor vehicle of the plurality of motor vehicles is anonymized before transferring the usage information to the provider. In particular, no vehicle identification number (VIN) is transferred to the electronic computing device, in particular it is not transferred to the provider. Therefore, the energy consumption of each motor vehicle is anonymized, which allows for higher data protection of each motor vehicle and therefore of each owner of each motor vehicle.

According to another embodiment the time frame is predefined by the provider. For example, the time frame can be a specific point in time, for example 12 o'clock, or the time frame can be a time period of for example 30 minutes. Therefore, the provider can set the format of the time frame and determine the power consumption in this time frame. Therefore, the provider can receive individual usage information in order to plan their future investment.

According to another embodiment, an amount of theoretically possible energy that could be charged to the plurality of motor vehicles in the geometrical map is transferred to the provider. Therefore, the provider can monitor if there is enough energy in the geometrical map or if the current energy consumption is close to the amount of possible energy, so the provider may invest in an upgrade in the geometrical map.

According to another embodiment, additionally a theoretically possible average and/or maximum power depending on the charging modes in the geometrical map is transferred to the provider. For example, a charging mode may be AC-loading or DC-loading. The provider may then monitor if new investment should be made in AC-charging or in DC-charging.

According to another embodiment, a forecast of a future power consumption is determined by the electronic computing device and the forecast is additionally transferred to the provider. The provider can monitor the future forecast and see if, for example, the power consumption is merely dependent on a current situation on a specific day or if the power consumption is an average power consumption over a longer period of time. Therefore, the provider may decide if there is more investment to be made.

Furthermore, the forecast is determined depending on future weather in the geometrical map and/or a day and/or the time frame and/or navigational routes of the plurality of motor vehicles. Therefore, the provider gains usage information that is of highly informative value in order to plan the investment of the provider in greater detail.

In particular, the method is a computer-implemented method. Accordingly, another aspect of the invention relates to a computer program product comprising program code means for performing a method according to the preceding aspect. Furthermore, the invention relates to a computer-readable storage medium comprising the computer program product.

Another aspect of the invention relates to an electronic computing device for providing usage information of an electrical grid to the provider of the electrical grid, comprising at least the computer program product according to the preceding aspect, wherein the electronic computing device is configured to perform a method according to the preceding aspect. In particular, the method is performed by the electronic computing device.

The electronic computing device comprises for example processors and circuits, for example integrated circuits, for performing the method.

Further advantages, features, and details of the invention derive from the following description of preferred embodiments as well as from the drawings. The features and feature combinations previously mentioned in the description as well as the features and feature combinations mentioned in the following description of the figures and/or shown in the figures alone can be employed not only in the respectively indicated combination but also in any other combination or taken alone without leaving the scope of the invention.

### BRIEF DESCRIPTION OF THE DRAWINGS

The novel features and characteristics of the disclosure are set forth in the appended claims. The accompanying drawings, which are incorporated in and constitute a part of this disclosure, illustrate exemplary embodiments and together with the description, serve to explain the disclosed principles. The same numbers are used throughout the figures to reference like features and components. Some embodiments of system and/or methods in accordance with embodiments of the present subject matter are now described below, by way of example only, and with reference to the accompanying figures.

The drawings show in:

FIG. 1 shows a schematic flow chart according to an embodiment of the method, and

FIG. 2 shows another schematic flowchart according to another embodiment of the method.

In the figures the same elements or elements having the same function are indicated by the same reference signs.

### DETAILED DESCRIPTION

In the present document, the word “exemplary” is used herein to mean “serving as an example, instance, or illustration”. Any embodiment or implementation of the present subject matter described herein as “exemplary” is not necessarily to be construed as preferred or advantageous over other embodiments.

While the disclosure is susceptible to various modifications and alternative forms, specific embodiments thereof have been shown by way of example in the drawing and will be described in detail below. It should be understood, however, that it is not intended to limit the disclosure to the particular forms disclosed, but on the contrary, the disclosure is to cover all modifications, equivalents, and alternatives falling within the scope of the disclosure.

The terms “comprises”, “comprising”, or any other variations thereof, are intended to cover a non-exclusive inclusion so that a setup, device, or method that comprises a list of components or steps does not include only those components or steps but may include other components or steps not expressly listed or inherent to such setup or device or method. In other words, one or more elements in a system or apparatus preceded by “comprises” or “comprise” does not or do not, without more constraints, preclude the existence of other elements or additional elements in the system or method.

In the following detailed description of the embodiment of the disclosure, reference is made to the accompanying drawing that forms part hereof, and in which is shown by way of illustration a specific embodiment in which the disclosure may be practiced. This embodiment is described in sufficient detail to enable those skilled in the art to practice the disclosure, and it is to be understood that other embodiments may be utilized and that changes may be made without departing from the scope of the present disclosure. The following description is, therefore, not to be taken in a limiting sense.

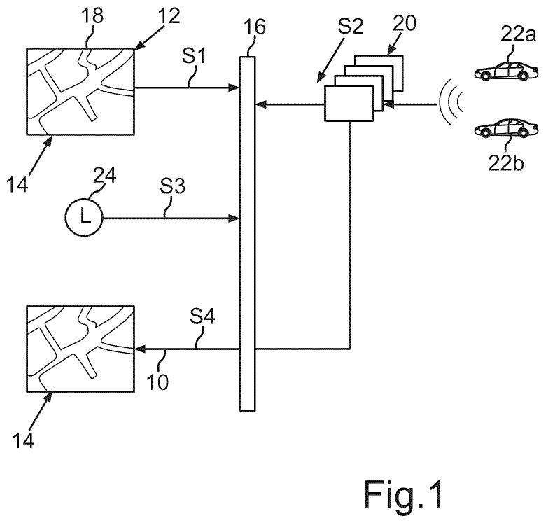

FIG. 1 shows a schematic flow chart according to an embodiment of a method for providing usage information 10 of an electrical grid 12 to a provider 14 of the electrical grid 12 by an electronic computing device 16. In a first step S1 an input of the provider 14 is captured, whereby the input defines a geometrical map 18 in the electrical grid 12. For example, the provider 14, which may be for example a so-called third party, provides the map 18 or location data, for example a polygon around a point of interest. This is, in particular, performed in the first step S1. In a second step S2 at least one power consumption 20 of a plurality of motor vehicles 22a, 22b in the geometrical map 18 is determined in a time frame. In a third step S3 at least one time stamp 24 for the at least one power consumption 20 is provided, in particular to the electronic computer device 16. The at least one power consumption 20 with the at least one time stamp 24 for the defined geometrical map 18 is transferred as the usage information 10 to the provider 14 in a fourth step S4.

FIG. 1 shows further that according to an embodiment the at least one power consumption 20 is aggregated depending on each power consumption of each motor vehicle 22a, 22b of the plurality of motor vehicles 22a, 22b. Furthermore, each motor vehicle 22a, 22b of the plurality of motor vehicles 22a, 22b is anonymized before transferring the usage information 10 to the provider 14. The time frame may be predefined by the provider 14.

According to another embodiment, additionally an amount of theoretically possible energy that could be charged to the plurality of motor vehicles 22a, 22b in the geometrical map 18 is transferred to the provider 14. Furthermore, a theoretically possible average and/or maximum power depending on charging modes in the geometrical map 18 is transferred to the provider 14.

For example, the energy usage pattern, which may be the power consumption 20, is an API response per use case per time bucket, wherein, for example, the time bucket may be 30 minutes. The time bucket corresponds to the time frame. In a first use case, wherein the provider 14 may save costs, the clustered range numbers of motor vehicles 22a, 22b, are transferred in the second step S2, wherein no individual vehicle identification number (VIN) is transferred to the provider 14. An amount of energy being charged, for example in kilowatt-hours, is transferred to the electronic computing device 16. Furthermore, an average and/or maximum power level or mode, in particular in kilowatt-hours of AC/DC power, is transferred to the electronic computing device 16 in the second step S2. In particular in the second step S2, data for each geometrical map 18, for example for each polygon, is calculated. In the third step S3, the data is being calculated for each polygon within the time frame, which may for example be the time bucket of 30 minutes. In the fourth step S4, the usage information 10 is returned to the provider 14 for the requested time frame.

According to the first use case, the provider 14 may be interested in updating or upgrading the electrical grid 12 for example with a transformer, inverter, or converter, power house, charging station, parking location, retail parking, public transportation space, or other power grid or charging infrastructure element. For this geometrical map 18, the power consumption 20 is calculated and the aggregated data is shared with the provider 14. According to the first use case, the predictive charging capacity or needs, for example based on navigational information, depends on the usage likelihood that at the same time on the next day or days the charging behavior is expected. Therefore, according to another embodiment a forecast of a future power consumption 20 is determined by the electronic computing device 16 and the forecast is additionally transferred to the provider 14. The forecast may be determined depending on future weather in the geometrical map 18 and/or a day and/or the time frame and/or navigational routes of the plurality of motor vehicles 22a, 22b.

According to a second use case, wherein the provider 14 may plan a strategic placement of charging infrastructure elements, in the second step S2 the clustered range number of motor vehicles 22a, 22b with no individual vehicle identification numbers is transferred to the electronic computing device 16. Furthermore, an amount of the possible energy that could be charged in kilowatt-hours is also transferred to the electronic computing device 16. Furthermore, theoretically possible average and/or maximum power levels or modes in kilowatt-hours of AC/DC are transferred to the electronic computing device 16. In particular, in the first step S1, the geometrical map 18, in particular the polygon data, is provided by the provider 14. In the second step S2, the power consumption 20 is calculated or determined for each geometrical map 18. In the third step S3, the data is being calculated for each polygon within the time frame. In the fourth step S4 the usage information 10 is returned to the provider 14 for the request in the time frame 24.

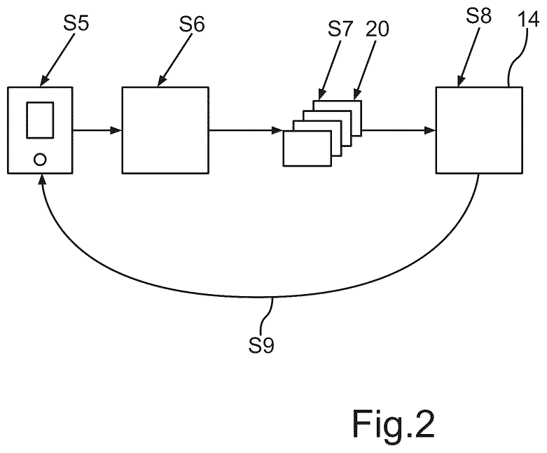

FIG. 2 shows another flowchart according to an embodiment of the method according to the invention. A user of the motor vehicles 22a, 22b agrees to the data log for the power consumption 20 in a fifth step S5. In a sixth step S6 the raw energy data, for example the charging state of the battery of the motor vehicles 22a, 22b, positions of the motor vehicles 22a, 22b, and the vehicle identification number are sent to the electronic computer device 16, which may be for example a backend. In a seventh step S7 the power consumption 20 is determined across the plurality of motor vehicles 22a, 22b, wherein the data is now anonymized. In an eighth step S8 the aggregated data shown as the usage information 10 is shared with the provider 14. In a ninth step S9 strategic upgrades of existing infrastructure elements and installation of new grid infrastructure may be planned.

1-10. (canceled)

11. A method comprising:
capturing an input of a provider of an electrical grid, wherein the input defines a geometrical map in the electrical grid;
determining, by an electronic computing device, at least one power consumption of a plurality of motor vehicles in the geometrical map in a time frame;
providing, by the electronic computing device, at least one time stamp for the at least one power consumption; and
transferring, by the electronic computing device, the at least one power consumption with the at least one time stamp for the defined geometrical map as the usage information to the provider.

12. The method of claim 11, wherein the at least one power consumption is aggregated depending on each power consumption of each motor vehicle of the plurality of motor vehicles.

13. The method of claim 11, wherein each motor vehicle of the plurality of motor vehicles is anonymized before transferring the usage information to the provider.

14. The method of claim 11, wherein the time frame is predefined by the provider.

15. The method of claim 11, wherein an amount of possible energy that could be charged to the plurality of motor vehicles in the geometrical map is transferred to the provider.

16. The method of claim 11, wherein a possible average or maximum power depending on charging modes in the geometrical map is transferred to the provider.

17. The method of claim 11, wherein a forecast of a future power consumption is determined by the electronic computing device and the forecast of the future power consumption is transferred to the provider.

18. The method of claim 17, wherein the forecast of the future power consumption is determined depending on future weather in the geometrical map, a day, the time frame, or navigational routes of the plurality of motor vehicles.

19. A non-transitory computer program product comprising program code, which when executed by an electronic computing device, causes the electronic computing device to:
capture an input of a provider of an electrical grid, wherein the input defines a geometrical map in the electrical grid;
determine at least one power consumption of a plurality of motor vehicles in the geometrical map in a time frame;
provide at least one time stamp for the at least one power consumption; and
transfer the at least one power consumption with the at least one time stamp for the defined geometrical map as the usage information to the provider.

20. An electronic computing device configured to:
capture an input of a provider of an electrical grid, wherein the input defines a geometrical map in the electrical grid;
determine at least one power consumption of a plurality of motor vehicles in the geometrical map in a time frame;
provide at least one time stamp for the at least one power consumption; and
transfer the at least one power consumption with the at least one time stamp for the defined geometrical map as the usage information to the provider.
